(19) United States
(12) Patent Application Publication
(10) Pub. No.: US 2016/0232552 A1
(43) Pub. Date: Aug. 11, 2016

(54) SERVER AND METHOD FOR PROVIDING REWARD TO DEVICE BASED ON POSITION INFORMATION OF DEVICE, AND DEVICE

(71) Applicant: MAKTB INC., Seoul (KR)

(72) Inventor: Hyun KIM, Seoul (KR)

(73) Assignee: MAKTB INC., Seoul (KR)

(21) Appl. No.: 15/022,293

(22) PCT Filed: Oct. 7, 2013
(86) PCT No.: PCT/KR2013/008940

§ 371 Date: Mar. 16, 2016

(51) Int. Cl. G06Q 30/02; H04W 4/02

(52) U.S. Cl. CPC G06Q 30/0222; H04W 4/023; G06Q 30/0261

(57) ABSTRACT

A server includes a storage unit configured to store position information of a shop; a position information acquiring unit configured to acquire position information of the device; a distance determination unit configured to determine whether a distance between the shop and the device is smaller than a first length based on the position information of the shop and the position information of the device; and a reward providing unit configured to provide a first reward to the device when the distance between the shop and the device is smaller than the first length. The reward providing unit provides a second reward to the device when the distance between the shop and the device is smaller than a second length, and the second length is smaller than the first length.

### TECHNICAL FIELD

The embodiments described herein pertain generally to a server and a method for providing a reward to a device based on position information of the device, and, also, relates to the device.

### BACKGROUND

Conventional advertising is intended for unspecified individuals and is mostly made regardless of customers' needs. Thus, it is difficult to evaluate the efficiency of the advertising. Such advertising method includes a method of producing advertisement flyers and distributing them to unspecified individuals, a method of advertising through a mass media such as radio or TV, a method of exposing, based on a search word on a web page, an advertisement similar to the search word, etc.

With regard to a method of providing an advertisement of a shop, Korean Patent Laid-open Publication No. 2013-0049231 describes a method that includes managing tag information per contents and per user by tagging a search word to a content selected among search results of the search word, analyzing interest information of a user terminal based on the tag information per user, and providing the user terminal with target information corresponding to the interest information of the user terminal.

### DISCLOSURE OF THE INVENTION

### Problems to be Solved by the Invention

Example embodiments of the present disclosure provide a server and a method of providing rewards to a device differentially based on a distance between a shop and the device, and, also, provide the device. Further, the example embodiments of the present disclosure provide a server and a method of increasing advertising efficiency by providing advertisement information of a shop corresponding to a region in which a user of a device is interested, and, also, provide the device. Moreover, the example embodiments of the present disclosure also provide a server and a method of providing a reward to a user of a device that has received and checked advertisement information of a shop, and, also, provide the device.

However, the problems sought to be solved by the present disclosure are not limited to the above description and other problems can be clearly understood by those skilled in the art from the following description.

### Means for Solving the Problems

An example embodiment provides a server including a storage unit configured to store position information of a shop; a position information acquiring unit configured to acquire position information of the device; a distance determination unit configured to determine whether a distance between the shop and the device is smaller than a first length based on the position information of the shop and the position information of the device; and a reward providing unit configured to provide a first reward to the device when the distance between the shop and the device is smaller than the first length. The reward providing unit provides a second reward to the device when the distance between the shop and the device is smaller than a second length, and the second length is smaller than the first length.

Another example embodiment provides a method of providing a reward, including storing position information of a shop; acquiring position information of the device; determining whether a distance between the shop and the device is smaller than a first length based on the position information of the shop and the position information of the device; providing a first reward to the device when the distance between the shop and the device is smaller than the first length; determining whether the distance between the shop and the device is smaller than a second length based on the position information of the shop and the position information of the device; and providing a second reward to the device when the distance between the shop and the device is smaller than the second length. The second length is smaller than the first length.

Yet another example embodiment provides a device configured to receive a reward including a position information generating unit configured to generate position information of the device; a transmitting unit configured to transmit the position information of the device to the server periodically; a reward receiving unit configured to receive a first reward from the server when a distance between the device and the shop is smaller than a first length; and a display unit configured to display an image regarding the received first reward on a display of the device. The reward receiving unit is further configured to receive a second reward from the server when the distance between the device and the shop is smaller than a second length, and the second length is smaller than the first length.

Still another example embodiment provides a method of receiving a reward including generating position information of the device; transmitting the position information of the device to a server; receiving a first reward from the server when a distance between the device and the shop is smaller than a first length; displaying an image regarding the received first reward on a display of the device, and receiving a second reward from the server when the distance between the device and the shop is smaller than a second length. The second length is smaller than the first length.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure.

### Effect of the Invention

According to the example embodiments, it is possible to provide a server and a method of providing rewards to a device differentially based on a distance between a shop and the device, and, also, to provide the device. Furthermore, it is also possible to provide a server and a method of increasing advertising efficiency by providing advertisement information of a shop corresponding to a region in which a user of a device is interested, and, also, to provide the device. In addition, it is also possible to provide a server and a method of providing a reward to a user of a device that has received and checked advertisement information of a shop, and, also, to provide the device.

### BRIEF DESCRIPTION OF THE DRAWINGS

FIG. 1 is a block diagram illustrating a reward providing system according to an example embodiment.

FIG. 2 is a block diagram illustrating a reward providing server shown in FIG. 1 according to an example embodiment.

FIG. 3 is a block diagram of a device shown in FIG. 1 according to an example embodiment.

FIG. 4 is a block diagram of a device shown in FIG. 1 according to another example embodiment.

FIG. 5 is a flowchart for describing a method of providing a reward according to an example embodiment.

FIG. 6 is a flowchart for describing a method of receiving a reward according to an example embodiment.

### MODE FOR CARRYING OUT THE INVENTION

Hereinafter, example embodiments will be described in detail so that inventive concept may be readily implemented by those skilled in the art. However, it is to be noted that the present disclosure is not limited to the example embodiments and examples but can be realized in various other ways. In drawings, parts not directly relevant to the description are omitted to enhance the clarity of the drawings, and like reference numerals denote like parts through the whole document.

Through the whole document, the terms “connected to” or “coupled to” are used to designate a connection or coupling of one element to another element and include both a case where an element is “directly connected or coupled to” another element and a case where an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

In the present specification, the term “unit” includes a unit implemented by hardware, a unit implemented by software, and a unit implemented by hardware and software both. Further, a single unit may be implemented by two or more hardware, and two or more units may be implemented by single hardware.

In the present specification, a part of operations or functions described to be performed by a terminal or a device may be performed by a server connected to the terminal or the user instead. Likewise, a part of operations or functions described to be performed by the server may be performed by the terminal or the device connected to the server instead.

Hereinafter, example embodiments will be described in detail with reference to the accompanying drawings.

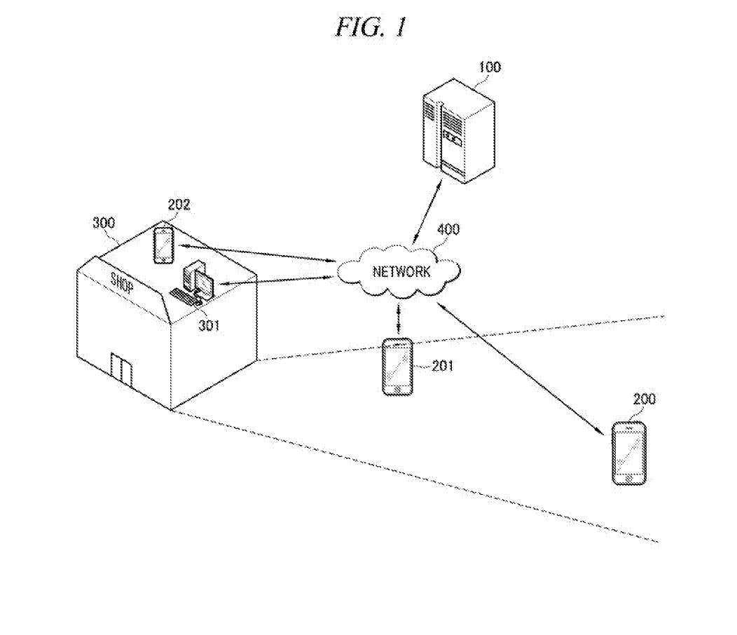

FIG. 1 is a block diagram illustrating a reward providing system according to an example embodiment of the present disclosure. As depicted in FIG. 1, the reward providing system includes a reward providing server 100, devices 200 (or 201 or 202) (which are distinguished based on position), and a shop device 301 installed in a shop 300. The reward providing system of FIG. 1 is, however, nothing more than an example according to one example embodiment of the present disclosure, and the example shown in FIG. 1 is not intended to limit the present disclosure. That is, the reward providing system may be configured differently from the example shown in FIG. 1 according to various other example embodiments of the present disclosure. By way of example, the reward providing system may further include a network base station and a wireless AP (Access Point).

Individual constituent components of the reward providing system of FIG. 1 are connected via a network 400. The network 400 implies a linking structure that allows individual nodes such as terminals and servers to exchange information therebetween. Examples of this network include, but not limited to, a 3GPP (3^{rd} Generation Partnership Project) network, a LTE (Long Term Evolution) network, a WIMAX (World Interoperability for Microwave Access) network, Internet, a LAN (Local Area Network), Wireless LAN (Wireless Local Area Network), a WAN (Wide Area network), a PAN (Personal Area network), a Bluetooth network, a satellite broadcasting network, an analog broadcasting network, a DMB (Digital Multimedia Broadcasting) network, and so forth.

The reward providing server 100 is configured to acquire position information of a shop and position information of the device 200 (or 201 or 202). To elaborate, the reward providing server 100 may acquire the position information of the shop 300 and the position information of the device 200 (or 201 or 202) from at least one of a base station of the device 200 (or 201 or 202) or the shop device 302 and an AP of the device 200 (or 201 or 202) or the shop device 301.

The reward providing server 100 may determine whether a distance between the shop 300 and the device 200 (or 201 or 202) is smaller than a preset length based on the position information of the shop 300 and the position information of the device 200 (or 201 or 202). Here, the preset length may be a distance indicating a likelihood that the device 200 (or 201 or 202) may visit the shop 300, a distance indicating that the device 200 (or 201 or 202) has visited the shop 300, or the like. Further, based on the determination upon the distance between the shop 300 and the device 200 (or 201 or 202), the reward providing server 100 may provide rewards to the device 200 (or 201 or 202) differentially. Here, the rewards may include a product discount coupon, a saving point, and so forth.

Besides, the reward providing server 100 may store times corresponding to individual times when it is determined that the distance between the shop 300 and the device 200 (or 201 or 202) is smaller than the preset length. Furthermore, the reward providing server 100 may calculate a time interval between the individual times and may provide a reward to the device 200 (or 201 or 202) based on the calculated time interval. By way of example, if the calculated time interval is within 10 minutes, the reward providing server 100 may provide the device 200 (or 201 or 202) with a product discount coupon that can be used in the shop 300.

Moreover, the reward providing server 100 may provide the reward to the device 200 (or 201 or 202) based on the number or the frequency of the visit of the device 200 (or 201 or 202) to the current position. Here, the current position may be a position within a region in which there is a chance that a user of the device 200 (or 201 or 202) may visit the shop 300, or may be a position of the shop 300. By way of example, if the number of visits of the device 200 (or 201 or 202) to the shop 300 is equal to or larger than 5, the reward providing server 100 may provide the device 200 (or 201 or 202) with a product discount coupon that can be used in the shop 300.

The reward providing server 100 may provide the device 200 (or 201 or 202) with advertisement information if the distance between the shop 300 and the device 200 (or 201 or 202) is smaller than the preset length. To be specific, the reward providing server 100 may provide the device 200 (or 201 or 202) with the advertisement information if the distance between the shop 300 and the device 200 (or 201 or 202) is smaller than the present length during the opening hour of the shop 300. Further, the reward providing server 100 may provide the device 200 (or 201 or 202) with the advertisement information if the distance between the shop 300 and the device 200 (or 201 or 202) is smaller than the preset length and the time that would be taken for the device 200 (or 201 or 202) to reach the shop 300 is smaller than a preset time length. By way of example, if the time that would be taken for the device 200 (or 201 or 202) to reach the shop 300 is 10 minutes and the preset time length is 20 minutes, the reward providing server 100 may provide the device 200 (or 201 or 202) with a product discount coupon that can be used in the shop 300.

Besides, the reward providing server 100 may provide the device 200 (or 201 or 202) with the advertisement information based on information of the shop 300 and user information of a user of the device 200 (or 201 or 202). Here, the information of the shop 300 may include information upon a service or a product that is sold in the shop 300, the position of the shop 300, a contact number of the shop 300, and so forth. The user information may include information of a shop 300 and a reward that are preferred by the user. The advertisement information may include introduction of products sold in the shop 300 or service provided therein, a recommended product, an opening hour of the shop 300, and so forth.

Furthermore, the reward providing server 100 may provide the device 200 (or 201 or 202) with the advertisement information based on the number or the frequency of visits of the device 200 (or 201 or 202) to the current position. Here, the current position may be a position within a region in which there is a chance for the user of the device 200 (or 201 or 202) to visit the shop 300. By way of example, if the device 200 (or 201 or 202) has been located five times or more within a region where there is a chance for the user of the device 200 (or 201 or 202) to visit the shop 300, the reward providing server 100 may provide the device 200 (or 201 or 202) with advertisement information including information upon a new product of the shop 300.

The device 200 (or 201 or 202) is configured to generate its position information and send the generated position information to the reward providing server 100 periodically. Here, the position information of the device 200 (or 201 or 202) may be at least one of GPS (Global Positioning system) information of the device 200 (or 201 or 202), base station information of device 200 (or 201 or 202), and AP (Access Point) information of the device 200 (or 201 or 202). Further, the device 200 (or 201 or 202) may be a terminal equipped with a receiver module capable of receiving the position information of the device 200 (or 201 or 202) from at least one of a GPS, a communication base station, and an AP.

If the distance between the devices 200 (or 201 or 202) and the shop 300 is smaller than the preset length, the device 200 (or 201 or 202) may receive a reward from the reward providing server 100 and display an image regarding the received reward on a display of the device 200 (or 201 or 202).

Besides, if the distance between the shop 300 and the device 200 (or 201 or 202) is smaller than the preset length, the device 200 (or 201 or 202) may receive advertisement information from the reward providing server 100 and display the received advertisement information on the display of the device 200 (or 201 or 202).

Further, the device 200 (or 201 or 202) may include a mobile terminal capable of performing wireless communications. According to various example embodiments of the present disclosure, the device 200 (or 201 or 202) may be implemented by various types of devices. By way of non-limiting example, each of the device 200 (or 201 or 202) may be implemented by a TV device, a computer or a mobile terminal capable of accessing a remote sever through a network. Here, an example of the TV device may include a smart TV, an IPTV setup box, and the like; an example of the computer may include a desktop computer, a laptop computer, a notebook computer equipped with a web browser, and the like; and an example of the mobile terminal may include, as a wireless communication device having portability and mobility, any of various kinds of handheld wireless communication devices such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a Wibro (Wireless Broadband Internet) terminal, a smartphone, a tablet PC, and so forth. Here, however, it should be noted that the device 200 (or 201 or 202) are not limited to the examples shown in FIG. 1 or specified above.

The shop 300 is a store that sells a product and a service. The product and the service sold in the shop may be online or offline product and service. The shop 300 includes the shop device 301 therein. The shop device 301 is connected to the reward providing server 100 through the network 400. The shop device 301 may be a payment device that proceeds with a payment process for the service or the product, or may be a near field communication device capable of determining, when the device 200 (or 201 or 202) is located close to it, whether the device 200 (or 201 or 202) is adjacent to it through near field communications.

Below, operations of the individual constituent components of the reward providing systems of FIG. 1 will be elaborated.

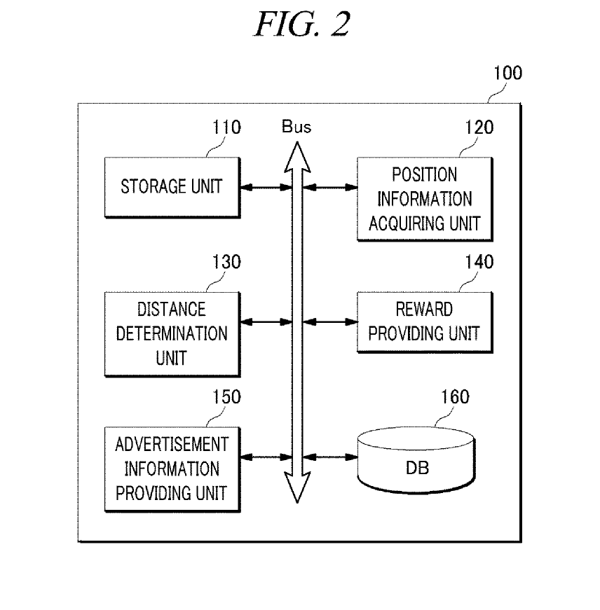

FIG. 2 is a block diagram of the reward providing server 100 shown in FIG. 1 according to an example embodiment of the present disclosure. As shown in FIG. 2, the reward providing server 100 includes a storage unit 110, a position information acquiring unit 120, a distance determination unit 130, a reward providing unit 140, an advertisement information providing unit 150 and a DB 160. Here, however, it should be noted that the reward providing server 100 shown in FIG. 2 is just an example of the present disclosure, and various modifications may be made based on the constituent components depicted in FIG. 2. By way of example, the reward providing server 100 may further include a user interface through which a command or information is input from a user. In such a case, the user interface may be implemented by a general input device such as a keyboard or a mouse, or may be implemented by a graphic user interface (GUI) that visually displays the command or the information on a video display.

The storage unit 110 is configured to store therein the position information of the shop 300 and the information of the shop 300. Here, the information of the shop 300 may include at least one of identification information of the shop, category information of the shop, and category information of a reward provided by the shop and advertisement information. The identification information of the shop 300 may include, for example, a name, an address and a phone number of the shop. The category information of the shop 300 may include, for example, the kind of a product and a service sold or recommended by the shop. By way of non-limiting example, the product sold in the shop may include food (e.g., Ramen, tripe, etc.), beverage and liquor (e.g., coffee, beer, etc.), clothes, fashion accessories (e.g., glasses, bags, hats, etc.), and so forth. The category information of the reward provided by the shop may include a product discount coupon, event information, information upon the period of discount, information upon a new product, and so forth. The advertisement information of the shop 300 may include information upon the opening hour of the shop, information upon the location of the shop, and so forth.

Besides, the storage unit 110 may also be configured to store position information of a plurality of shops 300.

The position information acquiring unit 120 is configured to acquire position information of the device 200 (or 201 or 202) and the user information upon the user of the device 200 (or 201 or 202). Here, the user information may include one or more of identification information of each user, category information of a shop preferred by the user and category information of a reward preferred by the user. The identification information of the user may include information upon, for example, a gender, an age, and a job of the user. The category information of the preferred shop may include information upon the kind of a product and a service that the user has interest in. By way of non-limiting example, the product that the user is interested in may include food (e.g., Ramen, tripe, etc.), beverage and liquor (e.g., coffee, beer, etc.), clothes, fashion accessories (e.g., glasses, bags, hats, etc.), or the like. The category information of the preferred reward may include a product discount coupon, event information, information upon the period of discount, information upon a new product, and so forth.

Furthermore, the position information acquiring unit 120 is configured to receive the position information of the shop 300 and the position information of the device 200 (or 201 or 202) from a position information generating server. Here, the position information generating server is capable of generating the position information of the shop 300 and the position information of the device 200 (or 201 or 202) from at least one of GPS information, base station information of the device 200 (or 201 or 202) and AP information of the device 200 (or 201 or 202). Besides, the position information acquiring unit 120 may also receive the position information of the shop 300 from the shop device 301.

The distance determination unit 130 is configured to determine whether the distance between the shop 300 and the device 200 (or 201 or 202) is shorter than a first length based on the position information of the shop 300 and the position information of the device 200 (or 201 or 202). Here, the first length may be a distance that indicates a likelihood that the device 200 (or 201 or 202) may visit the shop 300. In this case, the first length may be set to be, by way of example, but not limitation, a radius of 3 kilometers from the shop 300. In the following description, for the purposes of explanation, it is assumed that the first length is a radius of 3 kilometers from the shop 300.

According to another example embodiment of the present disclosure, the distance determination unit 130 may be configured to determine whether the distance between each of a plurality of shops 300 and the device 200 (or 201 or 202) is smaller than the first length based on position information of the plurality of shops 300 and the device 200 (or 201 or 202).

Further, the distance determination unit 130 may be configured to determine whether the distance between each of the plurality of shops 300 and the device 200 (or 201 or 202) is smaller than a second length based on the position information of the shops 300 and the position information of the device 200 (or 201 or 202). Here, the second length may be shorter than the first length. Further, the second length may be a distance between each shop 300 and the device 200 (or 201 or 202) when the device 200 (or 201 or 202) has actually visited the shop 300. In this case, the second length may be set to be equal to or shorter than 10 meters from the shop 300, but not limited thereto. In the following description, it is assumed that the second length is 10 meters from the shop 300.

The reward providing unit 140 may be configured to provide a first reward to the device 200 (or 201 or 202) when the distance between the shop 300 and the device 200 (or 201 or 202) is shorter than the first length. Here, the first reward may include, for example, a product discount coupon, a free product coupon, event information, and a saving point of the shop 300. Further, the first reward may be a settlement point that can be used in a plurality of shops. Here, the settlement point may be cash or a point that can be used like cash. According to another exemplary embodiment of the present disclosure, the reward providing unit 140 may provide the device 200 (or 201 or 202) with the first reward when a selection corresponding to advertisement information is input from the device 200 (or 201 or 202). Here, the advertisement information may be information that the reward providing server 100 has sent to the device 200 (or 201 or 202) when the distance between the shop 300 and the device 200 (or 201 or 202) is smaller than the first length and the current time is within the opening hour of the shop 300.

Furthermore, the reward providing unit 140 may provide a second reward to the device 200 (or 201 or 202) when the distance between the shop 300 and the device 200 (or 201 or 202) is smaller than the second length. Here, as compared to the first reward, the second reward may provide a higher product discount rate or a saving point twice as high as the saving point of the first reward, but not limited thereto. The second reward may include, for example, a product discount coupon, a free product coupon, and a saving point that can be used in the shop 300. Further, the second reward may be a settlement point that can be used in a plurality of shops. Here, the settlement point may be cash or a point that can be used like cash. Besides, the reward providing unit 140 may provide the second reward to the device 200 (or 201 or 202) based on a time interval between a first time when it is determined that the distance between the shop 300 and the device 200 (or 201 or 202) is smaller than the first length and a second time when it is determined that the distance between the shop 300 and the device 200 (or 201 or 202) is smaller than the second length. By way of example, the shorter the time interval between the first time and the second time may be, the higher the possibility of the user of the device 200 (or 201 or 202) visiting the shop 300 may become.

According to still another example embodiment of the present disclosure, the reward providing server 140 may provide the first reward or the second reward to the 200 (or 201 or 202) based on the number or the frequency of existence of the device 200 (or 201 or 202) at the current position. Here, the current position may include at least one of the first length, a region between the first length and the second length, and the second length. For example, if the frequency of the visit of the device 200 (or 201 or 202) to the current position is high, the device 200 (or 201 or 202) may receive, from the reward providing server 100, a product discount coupon that can be used in the shop 300.

The aforementioned first or second reward is a reward received from the reward providing server 100 and may imply a reward that can be used in (or only in) the shop 300 corresponding to this reward.

According to still another example embodiment of the present disclosure, when a selection upon first advertisement information of a first candidate shop is input from among advertisement information, the reward providing unit 140 may provide the device 200 (or 201 or 202) with a first reward corresponding to the first candidate shop. For example, when the user of the device 200 (or 201 or 202) has checked advertisement information of an optician's shop through the device 200 (or 201 or 202), the user may receive a product discount coupon that can be used in the optician's shop from the reward providing server 100. As another example, if the user of the device 200 (or 201 or 202) visits a liquor shop after checking advertisement information saying “one glass of free beer” through the device 200 (or 201 or 202), the user can be given a glass of beer for free from the corresponding liquor shop.

The reward providing unit 140 may provide a third reward to the device 200 (or 201 or 202) when a purchase process corresponding to the shop 300 proceeds through the device 200 (or 201 or 202). Here, the third reward may be a reward provided to the device 200 (or 201 or 202) only when the user of the device 200 (or 201 or 202) has purchased a product in the shop 300. Further, the third reward may be a settlement point that can be used in a plurality of shops. Here, the settlement point may be cash or a point that can be used like cash. This settlement point can be used in the plurality of shops including the shop 300. Here, the plurality of shops may be shops that have subscribed a certain service. The advertisement information providing unit 150 may provide advertisement information to the device 200 (or 201 or 202) when the distance between the shop 300 and the device 200 (or 201 or 202) is smaller than the first length. Here, the advertisement information may include advertisement data of the shop 300 and advertisement providing time. The advertisement data of the shop 300 may include the period of discount, the kind of goods that are discounted, and so forth. The advertisement providing time may include the opening hour of the shop 300. For example, the advertisement information providing unit 150 may provide the advertisement information to the device 200 (or 201 or 202) based on the advertisement providing time.

The amount of money corresponding to the advertisement information may be paid based on payment information of the shop 300. Here, the amount of money corresponding to the advertisement information may be an amount of money incurred when an owner of the shop 300 asks an advertising agency for advertisement of the shop 300. At this time, the amount of money may be a sum of at least one of a first amount of money, the first reward, the second reward and the third reward corresponding to the reward providing server 100. By way of example, when 500 won (W) is paid to the reward providing server 100 that provides the advertisement information; 200 won, to the device 200 (or 201 or 202) that has checked the advertisement information; 300 won, to the device 200 (or 201 or 202) that has actually visited the shop 300; 500 won, to the device 200 (or 201 or 202) that has proceeded, in the shop 300, a purchase corresponding to the shop 300, the total amount of money corresponding to the advertisement information may be 1500 won.

To elaborate, the advertisement information providing unit 150 may provide the advertisement information to the device 200 (or 201 or 202) when the distance between the device 200 (or 201 or 202) and the shop 300 is smaller than the first length and the current time is within the opening hour of the shop.

Further, the advertisement information providing unit 150 may provide the advertisement information to the device 200 (or 201 or 202)) when the distance between the device 200 (or 201 or 202) and the shop 300 is smaller than the first length and the time that would take for the device 200 (or 201 or 202) to reach the shop 300 is smaller than a threshold value (e.g., 10 minutes).

According to another example embodiment of the present disclosure, the advertisement information providing unit 150 may provide the device 200 (or 201 or 202) with the advertisement information based on the shop information and the user information of the user of the device 200 (or 201 or 202). By way of example, the advertisement information providing unit 150 may provide the device 200 (or 201 or 202) with an advertisement of the shop 300 matched with the current position of the user of the device 200 (or 201 or 202) and information upon a reward or a shop preferred by the user of the device 200 (or 201 or 202).

According to still another example embodiment of the present disclosure, the advertisement information providing unit 150 may provide the advertisement information to the device 200 (or 201 or 202) based on the number or the frequency of existence of the device 200 (or 201 or 202) at the current position. For example, when the frequency of the user of the device 200 (or 201 or 202) visiting the current position is high, the corresponding device 200 (or 201 or 202) may receive, from the reward providing server 100, an advertisement including information upon the kinds of products for discount, the prices thereof, and so forth.

According to yet another example embodiment of the present disclosure, the advertisement information providing unit 150 may select one or more candidate shops 300 from among a plurality of shops 300 when the distance between each of the plurality of shops 300 and the device 200 (or 201 or 202) is smaller than the first length, and may provide advertisement information of each of the selected candidate shops 300 to the device 200 (or 201 or 202).

The DB 160 is configured to store data therein. Here, the date stored in the DB 160 includes data input and output between the individual constituent components within the reward providing server 100, and also includes data input and output between the reward providing server 100 and constituent components outside the reward providing server 100. For example, the DB 106 may store the position information of the shop and the position information of the device 200 (or 201 or 202). Further, the DB 106 may store advertisement information, shop information and user information of the device 200 (or 201 or 202). An example of the DB 106 may be, but not limited to, a hard disk drive, a ROM (Read Only Memory), a RAM (Random Access Memory), a flash memory, or the like that exists within or outside the reward providing server 100.

It would be well understood by those skilled in the art that the position information acquiring unit 120, the distance determination unit 130, the reward providing unit 140, the advertisement information providing unit 150 and the DB 160 may be implemented as separate elements, or one or more of these components may be combined.

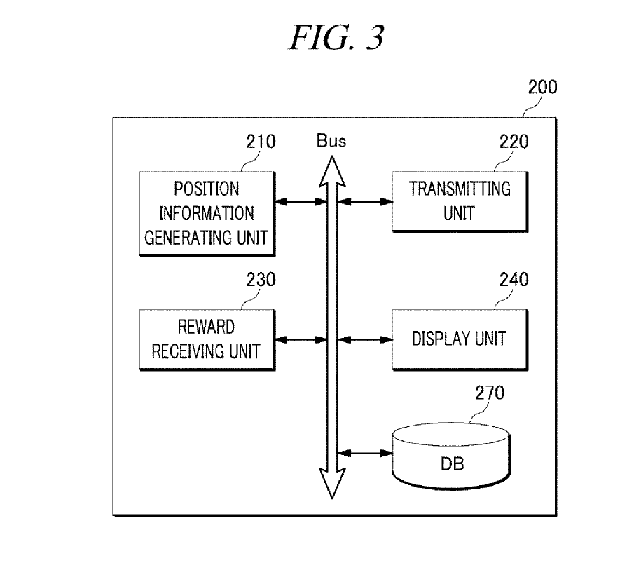

FIG. 3 is a block diagram illustrating the device 200 (or 201 or 202) shown in FIG. 1 according to an example embodiment of the present disclosure.

Referring to FIG. 3, the device 200 (or 201 or 202) includes a position information generating unit 210, a transmitting unit 220, a reward receiving unit 230, a display unit 240 and a DB 270. Here, however, it should be noted that the device 200 (or 201 or 202) depicted in FIG. 3 is nothing more than an example and can be modified in various ways based on the constituent components shown in FIG. 3. For example, the device 200 (or 201 or 202) may further include a user interface for receiving an input of a command or information from a user. In this case, the user interface may be implemented by a general input device such as a keyboard or a mouse, or may be implemented by a graphical user interface (GUI) that visually displays the information on a video display.

The position information generating unit 210 is configured to generate position information of the device 200 (or 201 or 202). Further, the position information generating unit 210 may receive the position information of the device 200 (or 201 or 202) from one or more of a GPS, a base station and an AP of the device 200 (or 201 or 202).

The transmitting unit 220 is configured to transmit the position information of the device 200 (or 201 or 202) to the reward providing server 100 periodically.

The reward receiving unit 230 may receive the first reward from the reward providing server 100 when the distance between the device 200 (or 201 or 202) and the shop 300 is smaller than a first length. Further, the reward receiving unit 230 may receive the second reward from the reward providing server 100 when the distance between the device 200 (or 201 or 202) and the shop 300 is smaller than a second length.

The display unit 240 may display an image regarding the first reward received from the reward providing server 100 on a display of the device 200 (or 201 or 202). Further, the display unit 240 also may display an image regarding the second reward received from the reward providing server 100 on the display of the device 200 (or 201 or 202).

The DB 270 may store therein the position information of the device 200 (or 201 or 202). Here, the data stored in the DB 270 may include data input and output between the individual constituent components within the device 200 (or 201 or 202), and also includes data input and output between the device 200 (or 201 or 202) and constituent components outside the device 200 (or 201 or 202). For example, the DB 270 may store therein the first reward and the second reward received from the reward providing server 100. An example of the DB 270 may be, but not limited to, a hard disk drive, a ROM (Read Only Memory), a RAM (Random Access Memory), a flash memory, or the like that exists within or outside the reward providing server 100.

It would be well understood by those skilled in the art that the position information generating unit 210, the transmitting unit 220, the reward receiving unit 230, the display unit 240 and the DB 270 may be implemented as separate elements, or one or more of these components may be combined.

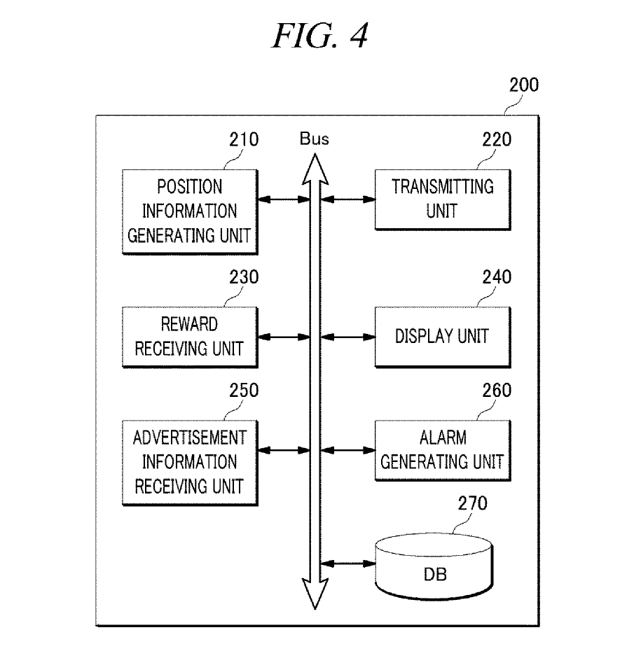

FIG. 4 is a block diagram illustrating the device 200 (or 201 or 202) shown in FIG. 1 according to another example embodiment of the present disclosure. Referring to FIG. 4, the device 200 (or 201 or 202) may include a position information generating unit 210, a transmitting unit 220, a reward receiving unit 230, a display unit 240, an advertisement information receiving unit 250, an alarm generating unit 260 and a DB 270. Here, however, it should be noted that the device 200 (or 201 or 202) depicted in FIG. 4 is nothing more than an example and can be modified in various ways based on the constituent components shown in FIG. 4. For example, the device 200 (or 201 or 202) may further include a user interface for receiving an input of a command or information from a user, the same as stated above with reference to FIG. 3.

The position information generating unit 210, the transmitting unit 220, the reward receiving unit 230, the display unit 240 and the DB 270 shown in FIG. 4 correspond to the position information generating unit 210, the transmitting unit 220, the reward receiving unit 230, the display unit 240 and the DB 270 of FIG. 3. Thus, redundant description thereof will be omitted.

The advertisement information receiving unit 250 may receive advertisement information from the reward providing server 100 when the distance between the device 200 (or 201 or 202) and the shop 300 is smaller than the first length.

The display unit 240 may display the advertisement information received from the reward providing server 100 on the display of the device 200 (or 201 or 202).

The alarm generating unit 260 is configured to generate an alarm corresponding to a user's selection upon advertisement information which is input from the user interface of the device 200 (or 201 or 202). Here, the user interface may be implemented in various forms such as a hardware button, a voice recognition interface, a gesture recognition interface, a touch interface, and so forth.

The transmitting unit 220 may transmit the alarm generated by the alarm generating unit 260 to the reward providing server 100.

The reward receiving unit 230 may receive the first reward from the reward providing server 100 after the corresponding alarm is sent to the reward providing server 100.

The DB 270 may store therein data input and output between the individual constituent components within the device 200 (or 201 or 202) and data input and output between the device 200 (or 201 or 202) and constituent components outside the device 200 (or 201 or 202), the same as stated above with reference to FIG. 3. In this case, the DB 270 may store the advertisement information received from the reward providing server 100.

It would be well understood by those skilled in the art that the position information generating unit 210, the transmitting unit 220, the reward receiving unit 230, the display unit 240, the advertisement information receiving unit 250, the alarm generating unit 260 and the DB 270 may be implemented as separate elements, or one or more of these components may be combined.

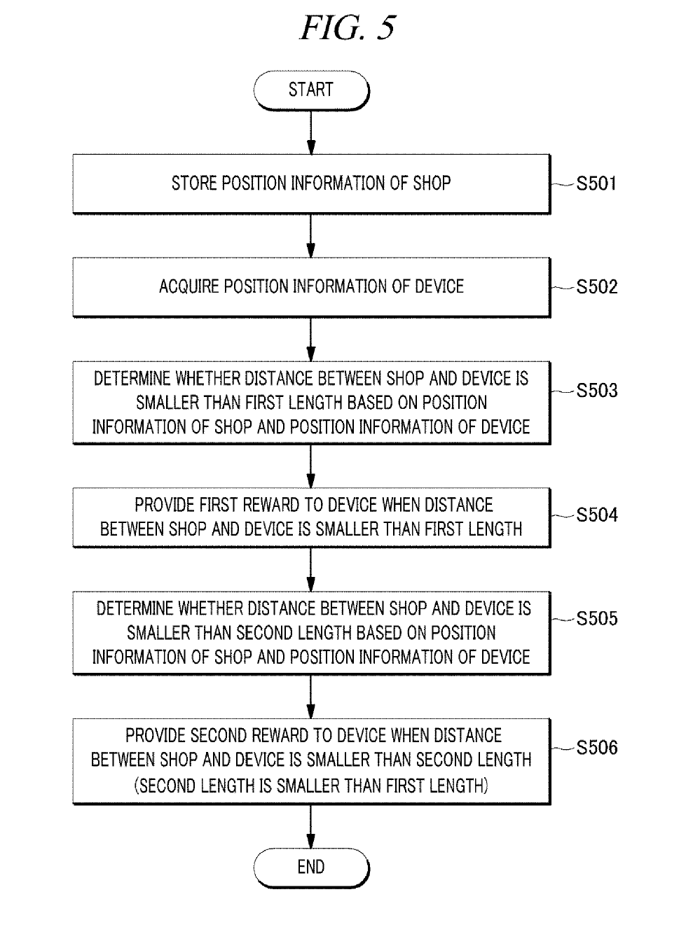

FIG. 5 is a flowchart for describing a method of providing a reward according to an example embodiment of the present disclosure. The method of providing the reward according to the example embodiment shown in FIG. 5 includes processing steps that are processed in time series in the reward providing server 100, the device 200 (or 201 or 202), the shop 300 and the shop device 301 according to the example embodiment shown in FIG. 4. Thus, though omitted in the following description, the disclosure set forth above regarding the reward providing server 100, the device 200 (or 201 or 202), the shop 300 and the shop device 301 in FIG. 1 to FIG. 4 can be applied to the method of providing the reward according to the example embodiment shown in FIG. 5.

Referring to FIG. 5, at step S501, the reward providing server 100 may store position information of the shop 300.

At step S502, the reward providing server 100 may acquire position information of the device 200 (or 201 or 202).

At step S503, the reward providing server 100 may determine whether the distance between the shop 300 and the device 200 (or 201 or 202) is smaller than a first length based on the position information of the shop 300 and the position information of the device 200 (or 201 or 202). Besides, the reward providing server 100 may provide advertisement information to the device 200 (or 201 or 202) when the distance between the shop 300 and the device 200 (or 201 or 202) is smaller than the first length.

At step S5004, the reward providing server 100 may provide a first reward to the device 200 (or 201 or 202) when the distance between the shop 300 and the device 200 (or 201 or 202) is smaller than the first length. Further, when a selection corresponding to the advertisement information is input from the device 200 (or 201 or 202), the reward providing server 100 may further provide the first reward to the device 200 (or 201 or 202).

At step S505, the reward providing server 100 may determine whether the distance between the shop 300 and the device 200 (or 201 or 202) is smaller than a second length based on the position information of the shop 300 and the position information of the device 200 (or 201 or 202).

At step S506, when the distance between the shop 300 and the device 200 (or 201 or 202) is smaller than the second length, the reward providing server 100 may provide a second reward to the device 200 (or 201 or 202). The second length may be shorter than the first length.

In the above description, steps S501 to S506 can be divided into additional steps or combined into fewer steps according to various example embodiments of the present disclosure. Further, a part of the steps can be omitted when necessary, and the order of the steps can be changed.

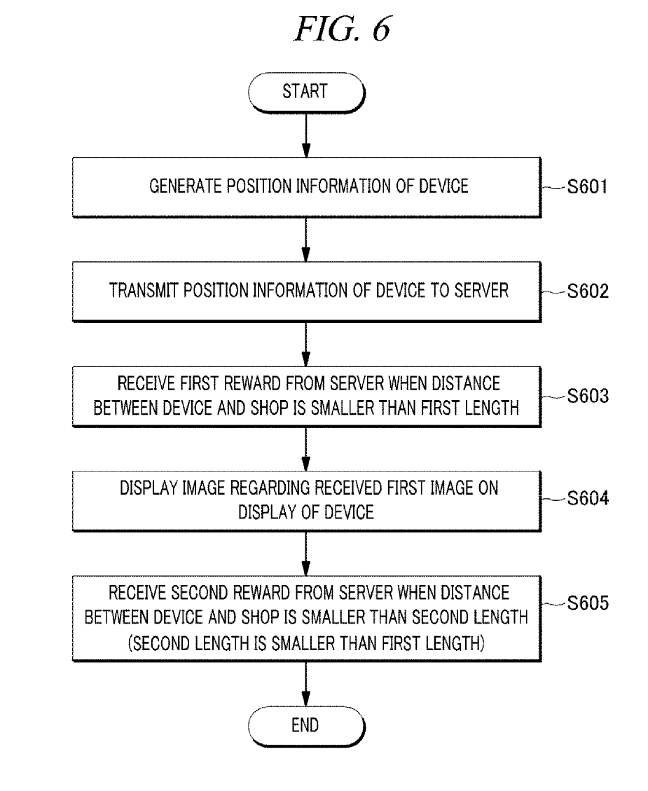

FIG. 6 is a flowchart for describing a method of receiving a reward according to an example embodiment of the present disclosure. The method of receiving the reward according to the example embodiment shown in FIG. 6 may include processing steps that are processed in time series in the reward providing server 100, the device 200 (or 201 or 202), the shop 300 and the shop device 301 according to the example embodiment shown in FIG. 1 to FIG. 5. Thus, though omitted in the following description, the disclosure set forth above regarding the reward providing server 100, the device 200 (or 201 or 202), the shop 300 and the shop device 301 FIG. 1 to FIG. 5 can be applied to the method of receiving the reward according to the example embodiment shown in FIG. 6.

Referring to FIG. 6, at step S601, the device 200 (or 201 or 202) may generate position information thereof.

At step S602, the device 200 (or 201 or 202) may transmit the position information thereof to the reward providing server 100. Further, when the distance between the device 200 (or 201 or 202) and the shop 300 is smaller than a first length, the device 200 (or 201 or 202) may receive advertisement information from the reward providing server 100. Besides, when a selection corresponding to the advertisement information is input from a user interface of the device 200 (or 201 or 202), the device 200 (or 201 or 202) may generate an alarm corresponding to the selection and transmit the alarm to the reward providing server 100.

At step S603, the device 200 (or 201 or 202) may receive a first reward from the reward providing server 100 when the distance between the device 200 (or 201 or 202) and the shop 300 is smaller than the first length. Further, the device 200 (or 201 or 202) may receive the first reward from the reward providing server 100 after the alarm is set to the reward providing server 100.

At block S604, the device 200 (or 201 or 202) may display an image regarding the first reward on a display of the device 200 (or 201 or 202).

At block S605, the device 200 (or 201 or 202) may receive a second reward from the reward providing server 100 when the distance between the device 200 (or 201 or 202) and the shop 300 is smaller than a second length. The second length is shorter the first length.

In the above description, steps S601 to S606 can be divided into additional steps or combined into fewer steps according to various example embodiments of the present disclosure. Further, a part of the steps can be omitted when necessary, and the order of the steps can be changed.

The example embodiments can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

1. A server that provides a reward to a device, comprising:
a storage unit configured to store position information of a shop;
a position information acquiring unit configured to acquire position information of the device;
a distance determination unit configured to determine whether a distance between the shop and the device is smaller than a first length based on the position information of the shop and the position information of the device; and
a reward providing unit configured to provide a first reward to the device when the distance between the shop and the device is smaller than the first length,
wherein the reward providing unit provides a second reward to the device when the distance between the shop and the device is smaller than a second length, and the second length is smaller than the first length.

2. The server of claim 1,
wherein the distance determination unit is further configured to determine whether the distance between the shop and the device is smaller than the second length based on the position information of the shop and the position information of the device, and
the reward providing unit is further configured to provide the second reward to the device based on a time interval between a first time when it is determined that the distance between the shop and the device is smaller than the first length and a second time when it is determined that the distance between the shop and the device is smaller than the second length.

3. The server of claim 1, further comprising:
an advertisement information providing unit configured to provide advertisement information to the device when the distance between the shop and the device is smaller than the first length,
wherein the reward providing unit is further configured to provide the first reward when a selection corresponding to the advertisement is input by the device.

4. The server of claim 3,
wherein the reward providing unit is further configured to provide a third reward to the device when a purchase process with regard to the shop is performed by the device.

5. The server of claim 4,
wherein one or more of the first reward, the second reward and the third reward is a settlement point capable of being used in a plurality of shops.

6. The server of claim 3,
wherein the advertisement information providing unit is further configured to provide the advertisement information to the device when the distance between the shop and the device is smaller than the first length and a current time is within an opening hour of the shop.

7. The server of claim 3,
wherein the advertisement information providing unit is further configured to provide the advertisement information to the device when the distance between the shop and the device is smaller than the first length and a time that is required for the device to reach the shop is smaller than a threshold value.

8. The server of claim 3,
wherein the storage unit is further configured to store the position information of the shop and shop information of the shop,
the position information acquiring unit is further configured to acquire the position information of the device and user information of a user of the device, and
the advertisement providing unit is further configured to provide the advertisement information to the device based on the shop information and the user information.

9. The server of claim 7,
wherein the advertisement information is advertisement information of the shop,
the user information includes at least one of identification information of the user, category information of a shop preferred by the user, and category information of a reward preferred by the user, and
the shop information includes at least one of identification information of the shop, category information of the shop, category information of a reward provided by the shop, and the advertisement information.

10. The server of claim 8,
wherein the advertisement information includes advertisement data and advertisement providing time, and
the advertisement information providing unit provides the advertisement information to the device based on the advertisement providing time.

11. The server of claim 3,
wherein the advertisement information providing unit is further configured to provide the advertisement information to the device based on a number or a frequency of existence of the device at a current position, and
the reward providing unit is further configured to provide the first reward or the second reward to the device based the number or the frequency of the existence of the device at the current position.

12. The server of claim 3,
wherein an amount of money corresponding to the advertisement information is paid based on payment information of the shop, and
the amount of money is a sum of a first amount of money corresponding to the server and at least one of the first reward, the second reward and the third reward.

13. The server of claim 3,
wherein the storage unit is further configured to store position information of a plurality of shops,
the distance determination unit is further configured to determine whether a distance between each of the shops and the device is smaller than the first length based on the position information of the plurality of shops and the position information of the device,
the advertisement information providing unit is further configured to select one or more candidate shops from the plurality of shops based on the determination result, and provide advertisement information of each of the selected candidate shops to the device, and
the reward providing unit is further configured to receive a selection of first advertisement information of a first candidate shop from among the advertisement of the each of the selected candidate shops from the device, and provide the first reward corresponding to the first candidate shop to the device.

14. The server of claim 1,
wherein each of the position information of the shop and the position information of the device is at least one of GPS (Global Positioning System) information, base station information and AP (Access Point) information.

15. The server of claim 1,
wherein the position information acquiring unit if further configured to receive the position information of the device from a position information generating server.

16. A method of providing a reward to a device, comprising:
storing position information of a shop;
acquiring position information of the device;
determining whether a distance between the shop and the device is smaller than a first length based on the position information of the shop and the position information of the device; and
providing a first reward to the device when the distance between the shop and the device is smaller than the first length,
determining whether the distance between the shop and the device is smaller than a second length based on the position information of the shop and the position information of the device, and
providing a second reward to the device when the distance between the shop and the device is smaller than the second length,
wherein the second length is smaller than the first length.

17. The method of claim 16, further comprising:
after determining whether the distance between the shop and the device is smaller than the first length, providing advertisement information to the device when the distance between the shop and the device is smaller than the first length,
wherein the providing of the first reward to the device includes providing the first reward when a selection corresponding to the advertisement information is input by the device.

18. A device configured to receive a reward from a server, comprising:
a position information generating unit configured to generate position information of the device;
a transmitting unit configured to transmit the position information of the device to the server periodically;
a reward receiving unit configured to receive a first reward from the server when a distance between the device and the shop is smaller than a first length; and
a display unit configured to display an image regarding the received first reward on a display of the device,
wherein the reward receiving unit is further configured to receive a second reward from the server when the distance between the device and the shop is smaller than a second length, and the second length is smaller than the first length.

19. The device of claim 18, further comprising:
an advertisement information receiving unit configured to receive advertisement information from the server when the distance between the device and the shop is smaller than the first length; and
an alarm generating unit configured to generate, when a selection of the advertisement information is input through a user interface, an alarm corresponding to the selection,
wherein the transmitting unit is further configured to transmit the alarm to the server, and
the reward receiving unit is further configured to receive the first reward from the server after the alarm is transmitted to the server.

20. A method of receiving a reward by a device, comprising:
generating position information of the device;
transmitting the position information of the device to a server;
receiving a first reward from the server when a distance between the device and the shop is smaller than a first length;
displaying an image regarding the received first reward on a display of the device, and receiving a second reward from the server when the distance between the device and the shop is smaller than a second length,
wherein the second length is smaller than the first length.

21. The method of claim 20, further comprising:
before receiving the first reward from the server, receiving advertisement information from the server when the distance between the device and the shop is smaller than the first length;
generating, when a selection of the advertisement information is input through a user interface, an alarm corresponding to the selection; and
transmitting the alarm to the server,
wherein the receiving of the first reward from the server includes receiving the first reward from the server after the alarm is transmitted to the server.

22. A computer-readable recording medium having stored thereon a program for implementing a method as claimed in claim 16 on a computer.
